(19) United States
(12) Patent Application Publication
(10) Pub. No.: US 2003/0200100 A1
(43) Pub. Date: Oct. 23, 2003

(54) Method and reminding assignment deadlines

(76) Inventors: Say-Yee Wen, Taipei (TW); Shih-Li Wen, Taipei (TW)

Correspondence Address: BIRCH STEWART KOLASCH & BIRCH, PO BOX 747, FALLS CHURCH, VA, 22040-0747, US

(21) Appl. No.: 10/124,342

(22) Filed: Apr. 18, 2002

(51) Int. Cl. G06F 17/60

(52) U.S. Cl. 705/1

(57) ABSTRACT

This specification discloses a method of reminding the assignment deadlines used in an electronic device and a connected host. The procedure is as follows: first, data are entered into the host; the host processes scheduling according to the data to obtain an assignment deadline reminder schedule; the host checks whether a scheduled reminding time in the assignment deadline reminder schedule is up; then the host transfers a reminder command to the electronic device; the electronic device shows the assignment deadline according to the command; and finally the electronic device deletes the assignment deadline reminder. The invention is thus capable of making assignment deadline reminders much easier.

### BACKGROUND OF THE INVENTION

1. Field of Invention

The invention relates to a method of reminding assignment deadlines and, in particular, to a method that utilizes an electronic device to facilitate assignment deadline reminders in the interactive teaching and learning.

2. Related Art

As electronic devices are widely used by people in daily, personal computers are often employed in teaching and learning. However, not all teaching or lecturing utilizes personal computers. This is because most of the courses are still taught in the conventional way. Even if personal computers are needed in class, they are often rarely used for practices or doing homework after the class.

The “E-bag” advocated by many people has the advantages of reducing the weight of books and providing multimedia AV teaching. Based upon this, the invention thus proposes to use electronic devices for interactive teaching and learning. Since teachers often need to continually remind the students about the homework assignments and yet the students may still be unable to remember when the assignments are due after the class, so oral reminders have their limitations. An assignment deadline reminding method which utilizes electronic devices for interactive teaching to facilitate assignment deadline reminders is thus highly desirable.

### SUMMARY OF THE INVENTION

It is an objective of the invention to provide a method of reminding assignment deadlines. With the help of an electronic device in interactive teaching and learning, the invention is capable of reminding assignment deadlines to prevent students from forgetting to hand in the homework assignments.

In accordance with the invention, the method is applied to electronic devices and a host connecting them and comprises the following steps:

first, data are entered into the host;

the host processes scheduling according to the data to obtain an assignment deadline reminder schedule;

the host checks whether a scheduled reminding time in the assignment deadline reminder schedule is up;

then the host transfers a reminder command to the electronic device;

the electronic device prompts the assignment deadline according to the command, where the reminder may be prompted on a screen or by voice; and

finally the electronic device deletes the assignment deadline reminder.

Through this method, the host can send assignment deadlines to several electronic devices at the same time. The reminders can be sent to personal electronic devices, to electronic devices of discussion group members, or to electronic devices of on-duty personnel.

### BRIEF DESCRIPTION OF THE DRAWINGS

The invention will become more fully understood from the detailed description given hereinbelow illustration only, and thus are not limitative of the present invention, and wherein:

FIG. 1 shows a system structure of the invention;

FIG. 2 is a flowchart of the invention;

FIG. 3 is a schematic view of a pie timer shown on a PDA according to the invention;

FIG. 4 is another flowchart; and

FIG. 5 is yet another flowchart.

### DETAILED DESCRIPTION OF THE INVENTION

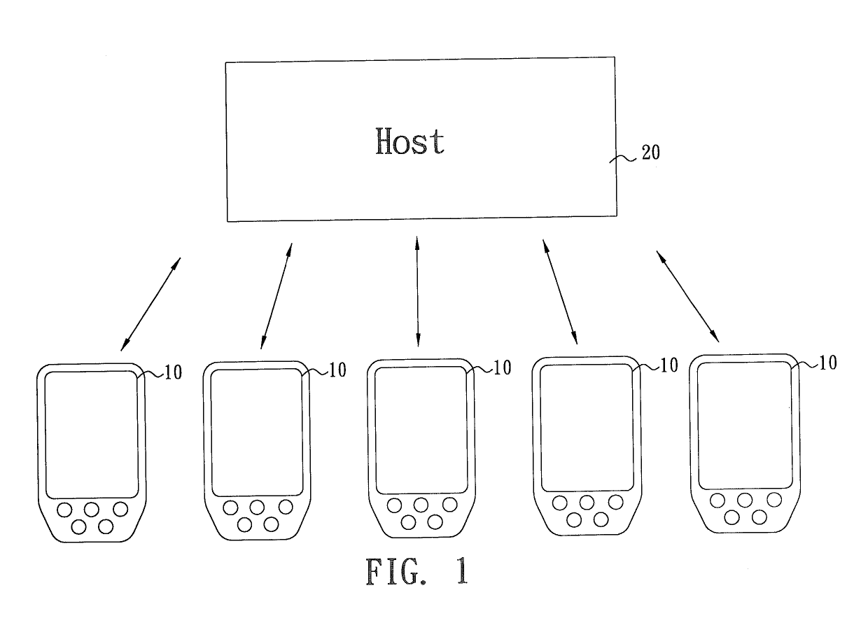

As shown in FIG. 1, the system structure of the invention has an electronic device (such as the PDA's 10, mobile phones, laptop computers or other types of electronic devices) selectively connected to a host 20. The user (student or teacher) carries the PDA 10 to the classroom or any place. As long as both parties are connected, data transfer can be performed. Moreover, the host 20 can send deadlines for homework assignments to the PDA 10 of another user. The deadline here refers to the one for turning in a recent homework assignment. Of course, when the teacher teaches a particular course, many PDA's are simultaneously connected to the host 20. Therefore, the host 20 can simultaneously send reminders for the assignments of the course to several PDA's 10. We have the following different reminding means in accordance with different purposes: sending personal assignment reminders to the PDA 10 of a particular person, sending group discussion reminders to the PDA's 10 of the group member, and sending duty reminders (e.g. preparing tea or coffee for the teachers) to the PDA 10 of the on-duty personnel.

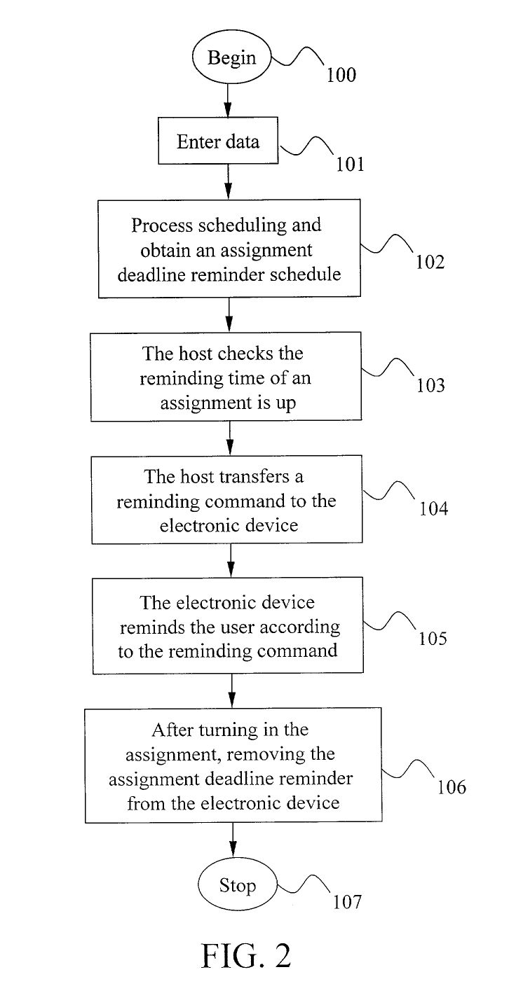

With reference to FIG. 2, the procedure of the method is as follows:

First, the method begins (step 100).

Data are then entered (step 101). The data include course names, assignments, assignment deadlines, and assignment reminders. Such data can be entered into a host or an electronic device (such as PDA, mobile phone, laptop computer, or some other type of device).

The data are then used to process scheduling and obtain an assignment deadline reminder schedule (step 102). Of course, such a process is performed at the place where the data are entered (the host or the electronic device). However, if the data are entered into an electronic device, the current step is followed by the step of transmitting the assignment deadline reminder schedule from the electronic device to the host.

The host then checks whether the reminding time of an assignment is up (step 103). The assignment reminding time is determined based upon the deadline of the assignment. It is normally earlier than the deadline by a fixed amount of time.

The host transfers a reminding command to the electronic device (step 104).

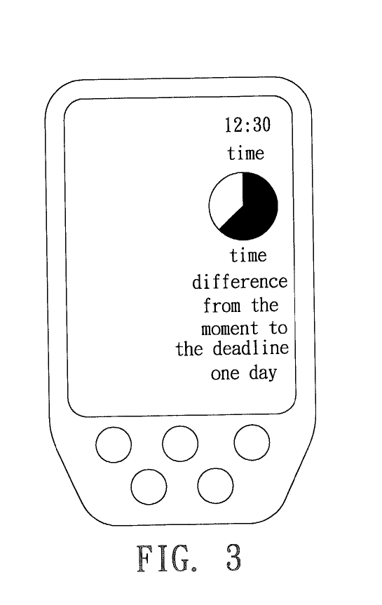

The electronic device then reminds the user according to the reminding command (step 105). The reminding method can be displaying the assignment deadline on a screen or by voice. The screen display means may be a pie timer displaying the time difference from the moment to the deadline (FIG. 3). The voice reminder can be set to beep at a particular time before the deadline and to beep again half time between the previous beep and the deadline.

After the assignment is turned in, the assignment deadline reminder is then removed from the electronic device (step 106). If the reminding means is screen display, then the screen is deleted. If the reminding means is by voice, then no voice will be played for this assignment deadline.

Finally, the procedure stops (step 107).

From the above description, one sees that the host can send assignment deadline reminders to several electronic devices at the same time. That is, the host can send out personal assignment reminders to particular persons, group report reminders to the discussion group members, and duty reminders to on-duty personnel.

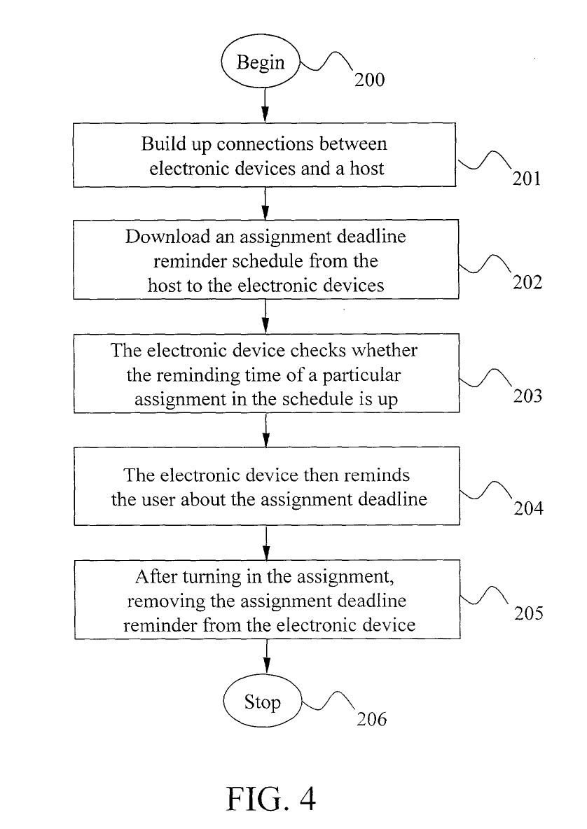

Another embodiment of the invention is shown in FIG. 4:

First, the procedure starts (step 200).

Build up connections between electronic devices and a host (step 201).

Download an assignment deadline reminder schedule from the host to the electronic devices (step 202).

The electronic device checks whether the reminding time of a particular assignment in the schedule is up (step 203). The assignment deadline reminder time is determined based upon the deadline. It is normally earlier than the deadline by a fixed amount of time.

The electronic device then reminds the user about the assignment deadline (step 204). The reminding method can be displaying the assignment deadline on a screen or by voice. The screen display means may be a pie timer displaying the time difference from the moment to the deadline. The voice reminder can be set to beep at a particular time before the deadline and to beep again half time between the previous beep and the deadline.

After the assignment is turned in, the assignment deadline reminder is then removed from the electronic device (step 205). If the reminding means is screen display, then the screen is deleted. If the reminding means is by voice, then no voice will be played for this assignment deadline.

Finally, the procedure stops (step 206).

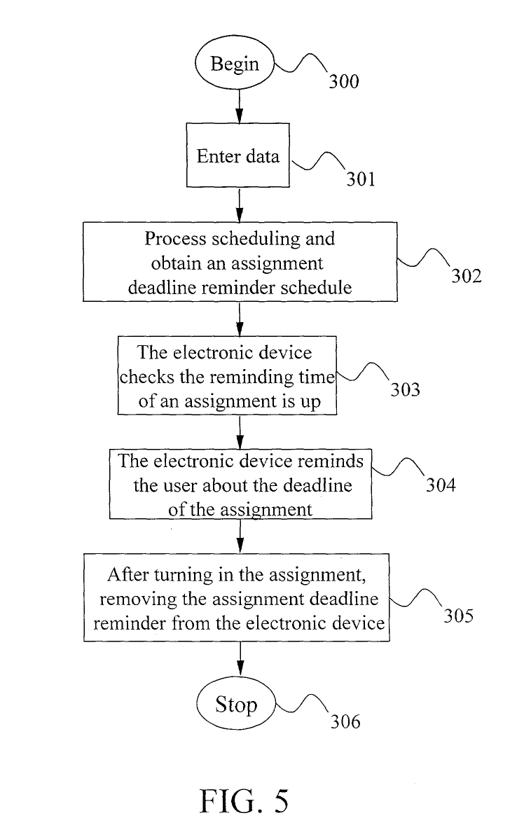

In yet another embodiment of the invention, the method is applied to electronic devices only. The procedure is illustrated in FIG. 5:

First, the procedure begins (step 300).

Data are then entered (step 301). The data include course names, assignments, assignment deadlines, and assignment reminders.

The data are then used to process scheduling and obtain an assignment deadline reminder schedule (step 302).

The electronic device then checks whether the reminding time of an assignment is up (step 303). The assignment reminding time is determined based upon the deadline of the assignment. It is normally earlier than the deadline by a fixed amount of time.

The electronic device then reminds the user about the deadline of the assignment (step 304). The reminding method can be displaying the assignment deadline on a screen or by voice. The screen display means may be a pie timer displaying the time difference from the moment to the deadline. The voice reminder can be set to beep at a particular time before the deadline and to beep again half time between the previous beep and the deadline.

After the assignment is turned in, the assignment deadline reminder is then removed from the electronic device (step 305). If the reminding means is screen display, then the screen is deleted. If the reminding means is by voice, then no voice will be played for this assignment deadline.

Finally, the procedure stops (step 306).

Different from the first embodiment, each of the electronic devices in the last two embodiments individually prompts the assignment deadline reminder before the deadline.

Effects of the Invention

The disclosed method can achieve the following effects:

1. The invention uses an electronic device to remind the user assignments due in the near future (i.e., the deadlines). This can facilitate assignment reminders so that the user will not forget the deadlines.

2. The invention uses multimedia (both audio and video) to produce assignment deadline reminders so that the user will not miss it.

3. The invention can remind the user about the assignments selectively at a time before the entered deadlines.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An assignment deadline reminding method used on an electronic device and a connected host for teaching and learning, which comprises the steps of:
entering data including a course name, an assignment for the course, a deadline for the assignment, and a reminding period for the assignment;
processing scheduling according to the data to obtain an assignment deadline reminder schedule;
using the host to check whether a scheduled reminding time in the assignment deadline reminder schedule is up, the reminding time being determined based upon the deadline of the assignment to be an appropriate period earlier than the deadline;
transmitting a reminder command from the host to the electronic device; and
reminding the assignment deadline by the electronic device to its user according to the reminder command.

2. The method of claim 1, wherein the step of reminding the assignment deadline by the electronic device to its user according to the reminder command is followed by the step of removing the assignment deadline reminder from the schedule by the electronic device.

3. The method of claim 1, wherein the step of reminding the assignment deadline by the electronic device to its user according to the reminder command is achieved using a method selected from the group consisting of audio play and video display.

4. The method of claim 3, wherein a pie timer is used to display the time difference between the current time and the assignment deadline when the video display method is utilized in the step of reminding the assignment deadline by the electronic device to its user according to the reminder command.

5. The method of claim 3, wherein the electronic device makes a first beep when the reminding time is up and makes each of the following beeps at the time half between its previous beep time and the assignment deadline when the audio display method is utilized in the step of reminding the assignment deadline by the electronic device to its user according to the reminder command.

6. The method of claim 1, wherein the step of entering data enters the data to the host and the step of processing scheduling according to the data to obtain an assignment deadline reminder schedule is performed by the host.

7. The method of claim 1, wherein the step of entering data enters the data to the electronic device and the step of processing scheduling according to the data to obtain an assignment deadline reminder schedule is performed by the electronic device, followed by the step of transmitting the assignment deadline reminder schedule from the electronic device to the host.

8. The method of claim 1, wherein the electronic device is selected from the group consisting of a PDA (Personal Digital Assistant), a mobile phone, and a laptop computer.

9. A assignment deadline reminding method used on an electronic device for teaching and learning, which comprises the steps of:
checking whether a scheduled reminding time in the assignment deadline reminder schedule is up, the reminding time being determined based upon the deadline of the assignment to be an appropriate period earlier than the deadline; and
reminding the assignment deadline.

10. The method of claim 9, wherein the step of checking whether a scheduled reminding time in the assignment deadline reminder schedule is up is preceded by the steps of:
entering data including a course name, an assignment for the course, a deadline for the assignment, and a reminding period for the assignment; and
processing scheduling according to the data to obtain an assignment deadline reminder schedule.

11. The method of claim 9, wherein the step of checking whether a scheduled reminding time in the assignment deadline reminder schedule is up is preceded by the steps of:
connecting the electronic device with a host; and
downloading the assignment deadline reminder schedule from the host to the electronic device.

12. The method of claim 9, wherein the step of reminding the assignment deadline is followed by the step of removing the assignment deadline reminder from the schedule by the electronic device.

13. The method of claim 9, wherein the step of reminding the assignment deadline is achieved using a method selected from the group consisting of audio play and video display.

14. The method of claim 13, wherein a pie timer is used to display the time difference between the current time and the assignment deadline when the video display method is utilized in the step of reminding the assignment deadline.

15. The method of claim 13, wherein the electronic device makes a first beep when the reminding time is up and makes each of the following beeps at the time half between its previous beep time and the assignment deadline when the audio display method is utilized in the step of reminding the assignment deadline.

16. The method of claim 9, wherein the electronic device is selected from the group consisting of a PDA (Personal Digital Assistant), a mobile phone, and a laptop computer.

17. A assignment deadline reminding method using a PDA (Personal Digital Assistant) and a connected host for interactive teaching and learning, which comprises the steps of:
entering data including a course name, an assignment for the course, a deadline for the assignment, and a reminding period for the assignment;
processing scheduling according to the data to obtain an assignment deadline reminder schedule;
using the host to check whether a scheduled reminding time in the assignment deadline reminder schedule is up, the reminding time being determined based upon the deadline of the assignment to be an appropriate period earlier than the deadline;
transmitting a reminder command from the host to the PDA; and
reminding the assignment deadline by the PDA according to the reminder command.

18. The method of claim 17, wherein the step of reminding the assignment deadline by the PDA according to the reminder command is followed by the step of removing the assignment deadline reminder from the schedule by the PDA.

19. The method of claim 17, wherein the step of reminding the assignment deadline by the PDA according to the reminder command is achieved using a method selected from the group consisting of audio play and video display.

20. The method of claim 17, of wherein the step of entering data enters the data to the PDA and the step of processing scheduling according to the data to obtain an assignment deadline reminder schedule is performed by the PDA, followed by the step of transmitting the assignment deadline reminder schedule from the PDA to the host.
